(19) United States
(12) Patent Application Publication
(10) Pub. No.: US 2007/0089680 A1
(43) Pub. Date: Apr. 26, 2007

(54) Animal model of anxiety and depression

(76) Inventor: Kenneth J. Sufka, Oxford, MS (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 11/549,322

(22) Filed: Oct. 13, 2006

Related U.S. Application Data
(60) Provisional application No. 60/726,121, filed on Oct. 13, 2005.

(51) Int. Cl. A01K 45/00; A01K 29/00

(52) U.S. Cl. 119/174

(57) ABSTRACT

This invention relates generally to animal models of anxiety and depression. Specifically, this invention relates to an in vivo high utility, high-throughput model for screening anxiolytic/antidepressant drugs in fowl chicks. This new animal model utilizes an inexpensive avian model, measures spontaneous behaviors in very young animals and is capable of detecting and/or differentiating a compound's anxiolytic and/or antidepressant effects. Animal costs are less than 10% of rodent costs and the assay can be run in a high-throughput mode.

### FIELD OF THE INVENTION

This invention relates generally to animal models of anxiety and depression. Specifically, this invention relates to an in vivo high utility, high-throughput model for screening anxiolytic/antidepressant drugs in fowl chicks.

### BACKGROUND OF THE INVENTION

Recent U.S. Mental Health Surveys report alarmingly high lifetime prevalence rates of 20.8% and 28.8% for mood disorders and anxiety disorders, respectively (R. C. Kessler et al, Lifetime Prevalence And Age-Of-Onset Distributions Of DSM-IV Disorders In The National Comorbidity Survey Replication, 62 Arch. Gen. Psychiatry 593-02 (2005)). While most who suffer from these clinical syndromes indeed seek treatment help, success rates for pharmacotherapy are only about 65%. Compounding this problem, for depression, is that no real new drug class has entered clinical use in the last 40 years (E. J. Nestler, Antidepressant Treatments in the 21^{st} Century, 44 Biol. Psych. 526-33 (1998)). Increases in success rates for the treatment of these and other syndromes rely, in part, on the discovery of novel pharmacotherapeutics in clinically relevant animal models and screening assays.

Rodent-based models have long been the mainstay in behavioral pharmacology research and there exist a number of screening assays to detect anxiolytic or antidepressant activity of novel drug candidates. However, rodent models can be labor-intensive and time consuming, are typically expensive to conduct and may demonstrate weak treatment or drug effects or worse, suffer from false positives and false negatives. These limitations suggest considering the development, validation and adoption of novel alternative models in behavioral pharmacology research.

Research from this laboratory has developed an in vivo high utility, high-throughput model for screening anxiolytic drugs in domestic fowl chicks (K. J. Sufka et al. Construct Validation of Behavioral Indices of Isolation Stress and Inflammatory Nociception in Young Domestic Fowl, 55 Physiol. Behav. 741-46 (1994); G. S. Watson et al., Chlordiazepoxide Reverses Social-Separation-Induced Distress Vocalizations and Analgesia in Young Domestic Fowl, 4 Exp. Clin. Psychopharm. 347-53 (1996)). Using separation-induced distress vocalizations (DVocs) to index anxiety (G. S. Watson et al., supra at 347-53), we have developed a set of procedures that allows for preclinical anxiolytic drug efficacy screening. (M. W. Feltenstein et al., The Chick Separation Stress Paradigm: A Validation Study, 77 Pharmacol. Biochem. Behav. 221-26 (2004); M. W. Feltenstein et al. Anxiolytic Properties of Piper Methysticum Extract Samples and Fractions in the Chick Social-Separation-Stress Procedure, 17 Phytother. Res. 210-16 (2003)). The chick separation stress paradigm possesses construct validity as an anxiety model in that separation stress reliably increases corticosterone levels (M. W. Feltenstein et al. Dissociation of Stress Behaviors in the Chick Social-Separation-Stress Procedure, 75 Physiol. Behav. 675-79 (2002)), a neuroendocrine marker of many stress responses. The model possesses predictive validity through the successful detection of diverse classes of anxiolytics (i.e., meprobamate, pentobarbital, chlordiazepoxide, imipramine and clonidine; (M. W. Feltenstein et al., supra at 221-26), and is sensitive to potency differences within an anxiolytic class (i.e., alprazolam, lorazepam and chlordiazepoxide; (G. S. Watson et al., Benzodiazepine Receptor Function in the Chick Social-Separation-Stress Procedure, 7 Exp. Clin. Psychopharm. 83-89 (1999)). Furthermore, the model is insensitive to a wide range of nonanxiolytic compounds (i.e., amphetamine, scopolamine, caffeine, chlorpromazine, and haloperidol; (M. W. Feltenstein et al., supra at 221-26). Finally, this paradigm has been used to identify anxiolytic activity in botanical extracts, extract fractions and isolated constituents in products marketed to consumer (K. J. Sufka et al. Anxiolytic Properties Of Botanical Extracts In The Chick Social Separation-Stress Procedure, 153 Psychopharm. 219-24 (2004)).

Domestic fowl chicks have also been used to model depression. (E. Lehr Distress Call Reactivation in Isolated Chicks: Behavioral Indicator With High Selectivity for Antidepressant Drugs, 97 Psychopharm. 145-46 (1989)) reports that chicks isolated for two hours entered into what was described as a “learned helplessness” state, a behavioral profile commonly associated with depression. In this study, Lehr reports that a wide variety of putative antidepressant drugs reversed this learned helplessness state while those lacking antidepressant activity did not. Unfortunately, a fine-grained analysis of this work is all but impossible as very limited methodological details (e.g., use of total count of distress vocalizations for the two hour period) and resultant data (e.g., all data presented as drug dose values in mg/kg for either 150% or 50% effect of control) were published. Nevertheless, what can be ascertained from this two-page report is that this paradigm, we believe, most certainly conflates two or more clinical syndromes.

One current perspective among some clinical psychologists suggests that anxiety and major depression may represent a single syndrome that only differs in symptom severity and/or duration. This notion is based on significant overlap in signs and symptoms of the two disorders and co-morbidity rates of approximately 70% between anxiety and depression (R. C. Kessler et al. Lifetime And 12-Month Prevalence Of DSM-III-R Psychiatric Disorders In The United States: Results For The National Comorbidity Survey, 51 Archives of General Psychiatry, 355-64 (1994)).

### SUMMARY OF THE INVENTION

This new animal model utilizes an inexpensive avian model, measures spontaneous behaviors in very young animals and is capable of detecting and/or differentiating a compound's anxiolytic and/or antidepressant effects. Animal costs are less than 10% of rodent costs and the assay can be run in a high-throughput mode. More specifically, this invention relates to a method to screen anxiolytic and antidepressant drugs in a plurality of fowl chicks. The step of this method involve: a) providing a plurality of fowl chicks, wherein a first portion of the fowl chicks receives at least one drug and a second portion of the fowl chicks do not receive the drug; audibly separating at least one fowl chick from the first portion and second portion of fowl chicks; detecting DVocs rate from the at least one separated fowl chicks at a first and second time; and b) comparing the DVocs rate of the at least one separated fowl chick from the first portion of fowl chicks and from the second portion of fowl chicks at a first and second time to screen for anxiolytic and antidepressant drugs.

Additionally, this invention relates to a system to screen for anxiolytic and antidepressant drugs. The system includes the elements: a plurality of fowl chicks, wherein a first portion of the plurality of fowl chicks receives at least one drug and a second portion of the plurality of fowl chicks that do not receive the at least one drug; means to audibly separate a fowl chick from the first portion of fowl chicks and from the second portion of fowl chicks; means to determine DVocs rate of the fowl chick from the first portion of fowl chicks and from the second portion of fowl chicks at a first and second time; and means to compare DVocs rate of the fowl chick from the first portion of fowl chicks and from the second portion of fowl chicks to screen for anxiolytic and antidepressant drugs.

### BRIEF DESCRIPTION OF THE DRAWINGS

A more complete understanding of the invention and its advantages will be apparent from the following Description of the Preferred Embodiment(s) taken in conjunction with the accompanying drawings, wherein:

FIG. 1 shows the effects of imipramine (15 mg/kg) and chlordiazepoxide (8 mg/kg) on mean distress vocalizations (±SEM) over a 120-minute. test period. Open symbols represent social test condition and closed symbols represent isolated test condition. Sample sizes were n=12.

FIG. 2 shows the effects of varying lengths of isolation (Iso) from social companions on mean distress vocalizations (±SEM). Chicks tested in the presence of two conspecifics for 60 minutes (Social 60) are represented by open squares. Sample sizes were n=12.

FIG. 3 shows the effects of varying lengths of social separation on mean (±S.E.M.) plasma corticosterone concentration (ng/mL). In No-Test birds, blood was collected immediately after removal from home cages (hatched bar). Social birds were tested in the presence of two conspecifics for 60 minute and blood was collected immediately after testing (gray bar). Six groups of birds were tested in isolation for various time points (i.e., 5, 10, 15, 20, 40, and 60 minute.) and blood was collected immediately after testing (closed bars). Sample sizes were n=6.

FIG. 4 shows the relationship between corticosterone levels (ng/mL) and distress vocalizations in all groups. (r=0.59, p<0.0001).

FIG. 5 shows the effects of chlordiazepoxide on isolation-induced DVocs across the 2 hr test session. Values represent mean (±SEM) DVoc for each 5 min time block. Chlordiazepoxide effects on the anxiety-like and depressive like phases of the test session are detailed in FIG. 6.

FIG. 6 shows Panel A highlights the effects of chlordiazepoxide on the isolation-induced DVoc rate during the anxiety phase of the isolation test session (0-5 min). Values represent mean (±SEM) DVoc. ‡ indicates significant increase in DVoc rate (stress effect) compared to the vehicle/social condition. * indicates a significant attenuation of DVocs (anxiolytic effect) compared to the vehicle/isolated condition. Panel B highlights the effects of chlordiazepoxide on the isolation-induced DVoc rate during the depression phase of the isolation test session (30-120 min). Values represent mean (±SEM) DVoc rate. * indicates a significant attenuation of DVocs compared to the vehicle/isolated condition. All p^{s}<0.05.

FIG. 7 shows the effects of clonidine on isolation-induced DVocs across the 2 hr test session. Values represent mean (±SEM) DVoc for each 5 min time block. Clonidine effects on the anxiety-like and depressive like phases of the test session are detailed in FIG. 8.

FIG. 8 shows Panel A highlights the effects of clonidine on the isolation-induced DVoc rate during the anxiety phase of the isolation test session (0-5 min). Values represent mean (±SEM) DVoc. ‡ indicates significant increase in DVoc rate (stress effect) compared to the vehicle/social condition. * indicates a significant attenuation of DVocs (anxiolytic effect) compared to the vehicle/isolated condition. Panel B highlights the effects of clonidine on the isolation-induced DVoc rate during the depression phase of the isolation test session (30-120 min). Values represent mean (±SEM) DVoc rate. * indicates a significant attenuation of DVocs compared to the vehicle/isolated condition. All p^{s}<0.05.

FIG. 9 shows the effects of imipramine on isolation-induced DVocs across the 2 hr test session. Values represent mean (±SEM) DVoc for each 5 min time block. Imipramine effects on the anxiety-like and depressive like phases of the test session are detailed in FIG. 10.

FIG. 10 shows Panel A highlights the effects of imipramine on the isolation-induced DVoc rate during the anxiety phase of the isolation test session (0-5 min). Values represent mean (±SEM) DVoc. ‡ indicates significant increase in DVoc rate (stress effect) compared to the vehicle/social condition. * indicates a significant attenuation of DVocs (anxiolytic effect) compared to the vehicle/isolated condition. Panel B highlights the effects of imipramine on the isolation-induced DVoc rate during the depression phase of the isolation test session (30-120 min). Values represent mean (±SEM) DVoc rate. † indicates a significant increase of DVocs (antidepressant effect) compared to the vehicle/isolated condition. All p^{s}<0.05.

FIG. 11 shows the effects of maprotoline on isolation-induced DVocs across the 2 hr test session. Values represent mean (±SEM) DVoc for each 5 min time block. Maprotoline effects on the anxiety-like and depressive like phases of the test session are detailed in FIG. 12.

FIG. 12 shows Panel A highlights the effects of maprotiline on the isolation-induced DVoc rate during the anxiety phase of the isolation test session (0-5 min). Values represent mean (±SEM) DVoc. ‡ indicates significant increase in DVoc rate (stress effect) compared to the vehicle/social condition. * indicates a significant attenuation of DVocs (anxiolytic effect) compared to the vehicle/isolated condition. Panel B highlights the effects of maprotiline on the isolation-induced DVoc rate during the depression phase of the isolation test session (30-120 min). Values represent mean (±SEM) DVoc rate. † indicates a significant increase of DVocs (antidepressant effect) compared to the vehicle/isolated condition. All p^{s}<0.05.

FIG. 13 shows the effects of fluoxetine on isolation-induced DVocs across the 2 hr test session. Values represent mean (±SEM) DVoc for each 5 min time block. Fluoxetine effects on the anxiety-like and depressive like phases of the test session are detailed in FIG. 14.

FIG. 14 shows Panel A highlights the effects of fluoxetine on the isolation-induced DVoc rate during the anxiety phase of the isolation test session (0-5 min). Values represent mean (±SEM) DVoc. ‡ indicates significant increase in DVoc rate (stress effect) compared to the vehicle/social condition Panel B highlights the effects of fluoxetine on the isolation-induced DVoc rate during the depression phase of the isolation test session (30-120 min). Values represent mean (±SEM) DVoc rate. † indicates a significant increase of DVocs (antidepressant effect) compared to the vehicle/isolated condition. All p^{s<}0.05.

FIG. 15 shows the time course of isolation-induced DVocs across the 2 hr test session for chicks in the interleukin-6 study. Values represent mean (±SEM) DVoc for each 5 min time block.

FIG. 16 shows the concentration of plasma concentration of interleukin-6 (pg/ml) across the 2 hr test session. Values represent mean (±SEM) concentration level. † indicates a marginally significant increase in plasma interleukin-6 concentration compared to the No-Test condition (p=0.067).

### DETAILED DESCRIPTION OF THE INVENTION

The present invention provides a high utility in vivo anxiolytic/antidepressant screening assay, one that models both anxiety and depression. More specifically, the invention provides a method to screen for anxiolytic and antidepressant drugs. The present model uses fowl chicks. Fowl chicks in the preferred embodiment are Gallus gallus. A first portion of the plurality of fowl chicks receive at least one of the drugs to be tested. A drug is an agent intended for use in the diagnosis, cure, mitigating treatment or prevention of a disease in humans. The term drug includes botanical drugs and nonbotanical drugs. An anxiolytic is a drug used in the treatment of anxiety.

In the preferred embodiment, one of each class of drugs to be tested is administered to the first portion of fowl chicks. A second portion of fowl chicks do not receive the drug and a function as the control. A fowl chick from the first and second portions is removed from the plurality of fowl chicks and placed in means to audibly separate the fowl chicks such as sound-attenuating enclosure. The DVoc rate for each of the audibly separated fowl chicks are determined by means such as microphones and electromagnetic counters. The DVoc rate is measured in the period that represents an anxiety state. In the preferred embodiment for the first 5 minutes, but this can range from 1 minute to 15 minutes. The DVocs rate is measured at a second period during the learned helplessness state which is akin to depression. In the preferred embodiment, the time is the 20-40 minute time block but can range from the 20-25 time block to 20-60 minute time block during the test session. The comparison of the DVoc rate from the fowl chick that received the drugs with the control provides a high-throughput model for screening anxiolytic and antidepressant drugs.

In Example 1, the pattern of distress vocalizations in response to social separation is characterized to show that both anxiety and depression can be modeled in young domestic fowl. In addition, evidence is provided that the model can detect and differentiate both anxiolytic and antidepressant drug effects (i.e., predictive validity). In Example 2, the neuroendocrine marker of stress corticosterone is characterized throughout the test session as a measure of convergent validity of the stress model.

Young domestic fowl separated from conspecifics exhibit a stress response characterized by a variety of behaviors including distress vocalizations (DVocs: G. G. Gallup et al. An Ethological Analysis Of Open-Field Behaviour In Chickens, 28 Animal Behavior, 368-78 (1980)). Conspecifics are animals of the same species. Distress vocalizations “DVocs” can be used to index anxiety (G. S. Watson et al. Chlordiazepoxide Reverses Social-Separation-Induced Distress Vocalizations and Analgesia in Young Domestic Fowl, 4 Exp. Clin. Psychopharm. 347-53 (1996)) and developed a set of procedures (chick separation stress paradigm) (M. W. Feltenstein et al. The Chick Separation Stress Paradigm: A Validation Study, 77 Pharmacol. Biochem. Behav. 221-26 (2004)) that allows the model to be used as a high-utility, high-throughput, early pre-clinical in vivo anxiolytic screening assay (Feltenstein et al. supra at 210-16). The model possesses construct validity as an anxiety model in that separation stress reliably increases corticosterone levels (M. W. Feltenstein et al., Dissociation Of Stress Behaviors In The Chick Social-Separation-Stress Procedure, 75 Physiol. Behav. 675-79 (2002)), a neuroendocrine marker of many stress responses. Additionally, the model possesses predictive validity through the successful detection of diverse classes of anxiolytics (i.e., meprobamate, pentobarbital, chlordiazepoxide, imipramine and clonidine; (M. W. Feltenstein et al. supra at 210-16) and being sensitive to potency differences within an anxiolytic class (i.e., alprazolam, lorazepam and chlordiazepoxide; (G. S. Watson et al., Benzodiazepine Receptor Function in the Chick Social-Separation-Stress Procedure. 7 Exp. Clin. Psychopharm, 83-89 (1999)). Furthermore, the model is insensitive to a wide range of nonanxiolytic compounds (i.e., amphetamine, scopolamine, caffeine, chlorpromazine, and haloperidol; (Feltenstein et al., supra at 221-26).

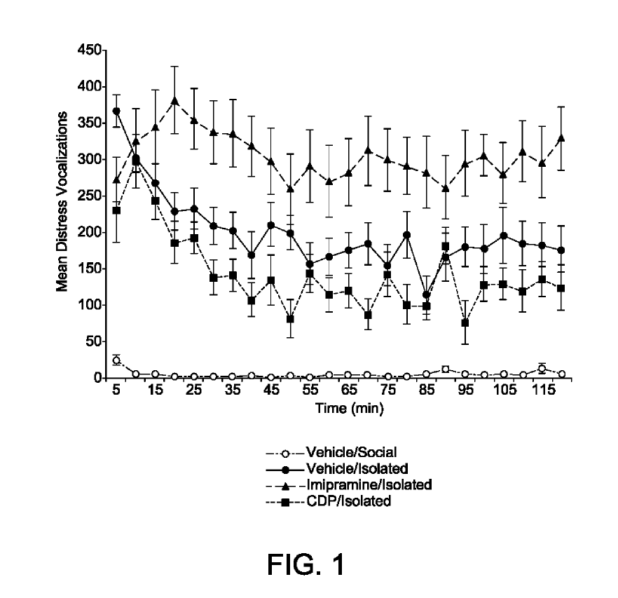

The effects of the two drug probes on separation-induced DVocs are summarized in FIG. 1. Vehicle chicks tested in the presence of two social companions exhibited few, if any, DVocs during the course of the test session. Isolation from social companions produced a robust DVoc response in vehicle chicks. The rate of DVocs declined over the first 30 minute of the test session to approximately 50% of the initial response rate and remained relatively stable thereafter. At the five minute block, both chlordiazepoxide and imipramine attenuated DVocs. However, at the 20 minute block and beyond, where vocalization rates had declined, imipramine enhanced DVoc rates. During this same time period chlordiazepoxide did not generally alter DVoc rates from that of isolated chicks.

Consistent with these descriptions, a two-way ANOVA revealed significant main effects for Treatment [F(3, 1012)=33.44,], Time [F(23, 1012)=7.67, p<0.0001], and a significant Treatment x Time interaction [F(69, 1012)=2.59, p<0.0001]. A one-way repeated measures for the vehicle-social group revealed a significant effect for Time [F(23, 253)=3.46, p<0.0001]. Post hoc analyses demonstrated that the only consistent and relevant difference in DVoc rates across time blocks was that chicks vocalized significantly more in the first five minute than each of the remaining test session blocks (p^{s}<0.005). To examine the ontogeny of learned helplessness, a one-way repeated measures for the vehicle-isolated group was performed and revealed a significant effect for Time [F(23, 253)=7.36, p<0.0001]. The results of post hoc analyses highlight three noteworthy patterns. First, DVocs were highest at the five minute time block and significantly lower for each of the remaining test session blocks (p^{s}<0.05). Second, there were no difference in DVoc rates between the 10 and 15 minute time blocks or the 15 and 20 minute time blocks as DVoc rates gradually declined; DVoc rates for the 30-120 portion of the test session were significantly lower than the 5-15 minute period (p^{s}<0.05). Finally, DVoc rates were generally stable across the 20-120 minute portion of the test session (p^{s}<0.05).

To examine the effects of the drug probes on patterns of DVocs, one-way ANOVAs were conducted at various test intervals. A one-way ANOVA at the first five minute time block revealed a significant treatment effect [F(3, 44)=24.53, p<0.0001]. Post hoc analyses demonstrated that the vehicle-isolated group vocalized significantly more than the vehicle-social group and that imipramine and chlordiazepoxide significantly reduced distress vocalizations in isolated groups (all p^{s}<0.0001). One way ANOVAs at the 10 minute [F(3, 44) =25.40, p<0.0001] and 15 minute [F(3, 44)=21.50, p<0.0001] time blocks revealed significant treatment effects. In both sets of analyses, post hoc tests demonstrated that distress vocalizations were significantly higher in all three isolated groups compared to the vehicle-social group (p^{s}<0.0001); no other relevant comparisons (i.e., effects of drug probes) reached statistical significance.

A one-way ANOVA at the 20 minute time block revealed a significant treatment effect [F(3, 44)=27.24, p<0.0001]. Post hoc analyses demonstrated that while vehicle-isolated DVoc rates had declined from their initial rate they were still significantly higher than vehicle-social chicks (p<0.0001). Interestingly, the decline in DVoc rates in vehicle-isolated chicks was reversed in chicks receiving imipramine (p<0.0001); chlordiazepoxide did not affect DVoc rates at this time block. In general, this pattern of treatment effects on DVoc rates remained consistent throughout the remainder of the test session [e.g., at 60 minute, F(3, 44)=13.46, p<0.0001 and at 120 minute, F(3, 44)=17.97, p<0.0001].

Distress vocalizations in the vehicle-social condition were at or below 25 DVocs/five minute block and remained stable throughout the two hour test session (see FIG. 1). In vehicle-isolated chicks, distress vocalizations exceeded 350 vocalizations in the first five minute block, gradually declined over the 10-20 minute, and then stabilized between 150 and 200 DVocs per five minute block throughout the remaining portion of the testing session. Thus, the pattern of DVocs in isolated chicks is characterized by three components rather than two suggested by (E. Lehr, Distress Call Reactivation in Isolated Chicks: Behavioral Indicator With High Selectivity for Antidepressant Drugs, 97 Psychopharm. 145-46 (1989)) and includes initial protest, behavioral despair and learned helplessness. Distress vocalizations are maximal at the beginning of the testing session, marking the initial protest phase. The next component, we describe here as behavioral despair and is characterized by the notable decrease in distress vocalizations in the next 10-15 minute of social separation. The final component, learned helplessness, is characterized by a reduced and stable pattern of distress vocalizations and was observed for the remainder of the test session.

Both chlordiazepoxide and imipramine attenuated DVocs during the first five minute time block, the phase we refer to as the initial protest. These findings are consistent with our previous work demonstrating that both anxiolytics and antidepressants possess anxiolytic properties in the chick separation stress paradigm (M. W. Feltenstein et al., supra 221-26). Imimpramine, but not chlordiazepoxide, enhanced DVocs rates beyond the 15 minute block as the chicks entered into the learned helplessness phase of the social separation response. This pattern of drug effects is consistent with the clinical literature in which anxiety states can be treated with either anxiolytics or antidepressants while depression is treated with only antidepressants and is unresponsive to anxiolytic classes of drugs. Taken together, these data argue that 1) the increase in DVocs during the initial protest represents an anxiety state that is sensitive to drug probes that possess anxiolytic properties and 2) diminished DVoc rates represents a learned helplessness state akin to depression that is sensitive to drug probes that possess antidepressant properties.

In Examples 3 and 4 a series of drug probes were used to test the efficacy of clinically established anxiolytics (i.e., chlordiazepoxide and clonidine) and anxiolytic/antidepressants (i.e., imipramine, maprotiline and fluoxetine) and a biochemical assay of the plasma IL-6 concentrations across the test session. Across the drug probes, the vehicle/isolated chicks had a robust exacerbation of DVocs compared to the vehicle/social chicks during the anxiety-like phase of the test session (i.e., the first five min block). All of the compounds, with the exception of fluoxetine, attenuated DVocs during this phase. Also, across the drug probes, the mean DVocs in the vehicle/isolated condition decreased over the first fifteen min to approximately 60% of the initial five min time block, which then remained stable throughout the test session (i.e., the depression-like phase). All of the anxiolytic/antidepressant compounds (i.e., imipramine, maprotiline and fluoxetine) were able to increase the mean number of DVocs within this phase of the test session.

Although fluoxetine has been shown in numerous experiments to be a clinically efficacious anxiolytic (Gorman et al. An Open Trial of Fluoxetine in the Treatment of Panic Attacks, 7 J. Clin. Psychopharmacol. 329-32 (1987); Michelson et al. Outcome Assessment and Clinical Improvement in Panic Disorder: Evidence From a Randomized Controlled Trial of Fluoxetine and Placebo, 155 Am. J. Psychiatry 1570-7 (1998); Michelson et al. Continuing Treatment of Panic Disorder after Acute Response: Randomized, Placebo-Controlled Trial With Fluoxetine, 174 Br. J. Psychiatry 213-08 (1999)), it is not surprising it did not attenuate DVocs during the anxiety-like phase of the test session due to the drug's strong serotonin reuptake inhibition (Fuller et al. In hibition of Serotonin Reuptake 36 Fed. Proc. 2154-8 (1977)). Serotonin release in the medio-rostral neostriatum/hyperstriatum ventrale has been found to be involved in the production of separation DVocs (Baldauf et al. Opiate Modulation of Monoamines in the Chick Forebrain: Possible Role In Emotional Regulation? 62 J. Neurobiol. 149-63 (2005)). While an argument can be made that not detecting fluoxetine represents a partial false negative for the model, it is also possible that the lack of effect may actually help further characterize the model's anxiety-like phase. A recent study in this laboratory demonstrated that the chick separation stress paradigm selectively detected drugs efficacious in the treatment of panic disorder (i.e., phenelzine, imipramine, alprazolam, and clonidine) and was insensitive to drugs selectively efficacious in treating generalized anxiety disorder (i.e., buspirone and trazodone; Warnick et al. Modeling Anxiety-Like States: Pharmacological Characterization of the Chick Separation Stress Paradigm 17 Behav. Pharmacol. 581-7 (2006)). While fluoxetine has been used clinically for the treatment of panic disorder (Gorman et al. An Open Trial of Fluoxetine in the Treatment of Panic Attacks 7 J. Clin. Psychopharmacol. 329-32 (1987)); Michelson et al. Outcome Assessment and Clinical Improvement in Panic Disorder: Evidence from a Randomized controlled Trial of Fluoxetine and Placebo 155 Am. J. Psychiatry 1570-7 (1998); Michelson et al. Continuing Treatment of Panic Disorder After Acute Response: Randomized, Placebol-Controlled Trial with Fluoxetine 174 Br. J. Psychiatry 213-8 (1999)), it has been shown to be ineffective in the treatment of situationally-bound panic disorder (Uhlenhuth et al. Do Antidepressants Selectivity Suppress Spontaneous (Unexpected) Panic Attacks? A Replication 20 J. Clin Psychopharmacol 622-7 (2000)). It is possible that instead of being a false negative, fluoxetine further defines the anxiety-like phase as modeling situationally-bound panic disorder.

The pattern of drug effects found in the current experiment help to further establish the face validity of this system. The system was able to 1) detect all of the investigatory anxiolytic agents that are efficacious for situationally-bound panic disorder (i.e., clonidine, chlordiazepoxide, imipramine & maprotiline), 2) detect all of the investigatory antidepressant agents (i.e., imipramine, maprotiline, and fluoxetine), and 3) show discriminate validity as the anxiolytics did not show antidepressant activity. Further, the efficacy of the antidepressants show a pattern similar to that found in humans. The dosage and clinical efficacy of imipramine, fluoxetine and maprotiline have been found to be virtually identical in humans (Baldessarini The Pharmacological Basis of Therapeutics (10^{th} Ed.) Hardman J G, Limbird L E (editors) New York: McGraw-Hill; pp. 447-83 (2001); Beasley et al. Fluoxetine Compared With Imipramine In The Treatment of Inpatient Depression. A Multicenter Trial 5 Ann. Clin. Psychiatry 199-07 (1993); de Jonghe et al. A Randomized, Double-Blind Study of Fluoxetine and Maprotiline in the Treatment of Major Depression 24 Pharmacopsychiatry 62-7 (1991); Logue et al. Comparisons of Maprotiline With Imipramine in Severe Depression: A Multicenter Controlled Trial 19 J. Clin. Pharmacol. 64-74 (1979); Nielsen et al. A Comparison of Fluoxetine and Imipramine in the treatment of Outpatients With Major Depressive Disorder 87 Acta. Psychiatr. Scand. 269-72 (1993); Wells et al. Chemistry, Pharmacology, Pharmacokinetics, Adverse Effects, and Efficacy of the Antidepressant Maprotiline Hydrochloride 1 Pharmacotherapy 121-39 (1981)). A comparison of the ED₅₀(CI₉₅) values of these compounds in the current model reveal virtually identical drug effects across the three compounds (Table 1). In addition to furthering the face validity, these findings also provide some preliminary evidence of the model possessing construct validity. That is, similarities in pharmacological profiles suggest similarities in neurobiology (Willner Behavioural Models In Psychopharmacology. In: Behavioral Models in Psychopharmacology: Theoretical, Industrial and Clinical Perspectives Willner P. (editor) Cambridge: Cambridge University Press pp. 3-18 (1991)).

TABLE 1
Experiment 1: ED₅₀ and CI₉₅ Values for the Antidepressant
(AD) Effect of Clinically Efficacious Compounds.

| | AD Effect | AD Effect | AD Effect | AD Effect | AD Effect |
|---|---|---|---|---|---|
| | (20-40 min | (40-60 min | (60-80 min | (80-100 min | (100-120 min |
| | time block) | time block) | time block) | time block) | time block) |
| Imipramine | | | | | |
| ED₅₀ | N/A | 10.0 | 8.5 | 9.1 | 7.6 |
| CI₉₅ | N/A | 7.8-13.9 | 6.7-11.6 | 7.0-13.0 | 5.9-10.7 |
| Maprotiline | | | | | |
| ED₅₀ | 17.2 | 14.0 | 14.9 | 13.6 | 14.6 |
| CI₉₅ | 12.9-25.7 | 10.7-20.2 | 11.4-21.7 | 10.4-19.8 | 10.9-22.1 |
| Fluoxetine | | | | | |
| ED₅₀ | N/A | 16.5 | 13.3 | 14.0 | 14.0 |
| CI₉₅ | N/A | 12.9-25.7 | 10.4-18.6 | 10.7-20.0 | 10.8-19.8 |

In the biochemical assay, plasma IL-6 concentration was found to change during the course of the test session (i.e., increased concentration at 120 min of social separation). Clinical studies have shown that major depression is associated with increased levels of cytokines, including elevated plasma IL-6 concentrations (Pike et al. Dissocation of Inflammatory Markers and Natural Killer Cell Activity In Major Depressive Disorder 49 Psychiatry 13-6 (2006)). Animal models of depression have displayed equivocal results with most showing no change in plasma IL-6 (Dunn et al. Cytokines As Mediators of Depression: What Can We Learn from Animal Studies? 29 Neurosci. Biobehav. (2005); e.g., chronic mild stress: Mormède et al. Chronic Mild Stress in Mice Decreases Peripheral Cytokine and Increases Central Cytokine Expression Independently of IL-10 Regulation of the Cytokine Network 10 Neuroimmunomodulation 359-66 (2003)) and a limited number of showing increases (e.g., restraint stress depression model: Zhou et al. Exposure to Physical And Psychological Stressors Elevates Plasma Interleukin 6: Relationship to the Activation of Hypothalamic-Pituitary-Adrenal Axis 133 Endocrinology 2523-30 (1993)). Thus, the ability of the model to increase plasma IL-6 levels not only provides evidence of the model's construct validity, it sets it apart from the depression models that are unable to produce such neuroimmunological changes.

It should be noted that the increased plasma concentration of IL-6 could also be indicative of processes other than that accompanying depressive symptomology. For example, in humans, IL-6 has been shown to be elevated in response to sustained physical activity (Northoff et al. Immunologic Mediators as Parameters of the Reaction to Strenuous Exercise 12 Int. J. Sports. Med. S9-S15 (1991)). It is possible that the elevated concentration of IL-6 found in the current study could be the result of the two hrs of persistent Dvocs.

### EXAMPLE 1

Subjects. Cockerels (Gallus gallus, strain W-36; Cal-Maine Foods, Mendenhall, Miss., USA) were obtained 1 day posthatch and housed in stainless steel cages (34×57×40 cm) at a population density of 12 chicks per cage. Food (Purina Start and Grow, St. Louis, Mo., USA) and water were available ad libitum through a 1-quart gravity-fed feeders and waterers. Room temperature was maintained at 29±1° C. and overhead florescent illumination was maintained on a 12-h light-dark cycle provided by fluorescent overhead lighting.

Apparatus. A six-unit test apparatus containing Plexiglas viewing chambers (25×25×22 cm) situated in sound-attenuating enclosures was used for behavioral data collection. The units were illuminated using 25-W light bulbs and ventilated by an 8-cm-diameter rotary fan. Miniature video cameras mounted at floor level in the corner of the enclosures allowed for animal observation. Microphones that mounted at the ceiling of the Plexiglas chamber were connected to digital sound-activating relays, which activated electromechanical counters. A white noise generator provided room masking noise.

Procedure. Tests were conducted at either Day 4, 5, or 6 post-hatch. Groups formed a single factorial design with a hanging control that included two vehicle-control groups in which chicks were tested in either an isolated or social condition, and two drug groups under the isolation condition. The vehicle was 0.9% physiological saline and the drug probes were chlordiazepoxide (8 mg/kg) and imipramine (15 mg/kg). Sample sizes were n=12 per cell.

Vehicle and drug injection were administered IP 15 minute before tests. The stress manipulation involved placing a chick in the observation chamber in isolation or in the presence of two conspecifics (social test condition) for a 120 minute test period. The dependent measure of distress vocalizations (DVocs) was collected in five minute time blocks. Animals were returned to their home cage following tests. All experimental procedures complied with the NIH Principles of Laboratory Animal Care (NIH publication # 86-23 1996) and were approved by the University of Mississippi IACUC (protocol # 04-020).

Statistics. Data were analyzed using one- and two-way repeated measures analysis of variance (ANOVA) and one-way simple effects ANOVA. Post hoc analyses were conducted using Fisher's LSD.

### EXAMPLE 2

Corticosterone is a biological marker of stress in animals and we have used this marker to provide convergent validity of the chick separation stress paradigm as a model of anxiety (M. W. Feltenstein, et al. Corticosterone Response In The Chick Separation-Stress Paradigm, 78 Physiol. Behav. 489-93 (2003). In Example 2, we attempt to provide evidence of convergent validity to the model by quantifying the pattern of corticosterone response in chicks during the three phases of the test session (i.e., initial protest, behavioral despair and learned helplessness). Because no appreciable changes were detected in DVoc rates during the last 90-100 minute, the test session was shortened to one hour in length in Example 2.

Subject and test apparatus were as described in Experiment 1. Tests were conducted 4-5 days post-hatch and in the first third of the light portion of the 12:12 light-dark cycle. The experimental design consisted of 7 treatment conditions that included one social group (test length=60 minute) and six isolated groups (test lengths=5, 10, 15, 20, 40 and 60 minute). Sample sizes were n=12. Following behavioral data collection, half the subjects from each group were taken from the test apparatus and rapidly decapitated for blood collection. Prior to conducting behavioral tests, a no-test control group (no stress manipulation) was taken from their home cages for blood collection. All blood samples were collected in EDTA tubes and were immediately chilled. These procedures were approved by the University of Mississippi's IACUC (protocol # 05-008).

Corticosterone Assay. Blood samples were centrifuged for 15 minute at 3000 rpm. Supernatants were collected and stored at −80° C. until analysis. Plasma corticosterone concentrations were determined by radioimmunoassay (Coat-a-Count RIA Kit: Diagnostic Products, Los Angeles, Calif.). The inter-assay coefficient of variations was 2.72%, the intra-assay coefficient was 1.84% and the R² of the standards was 0.982.

Statistical analyses. Statistical analyses one these data included one-way and two-way ANOVAs, Fisher's LSD, t-tests and Pearson's correlation.

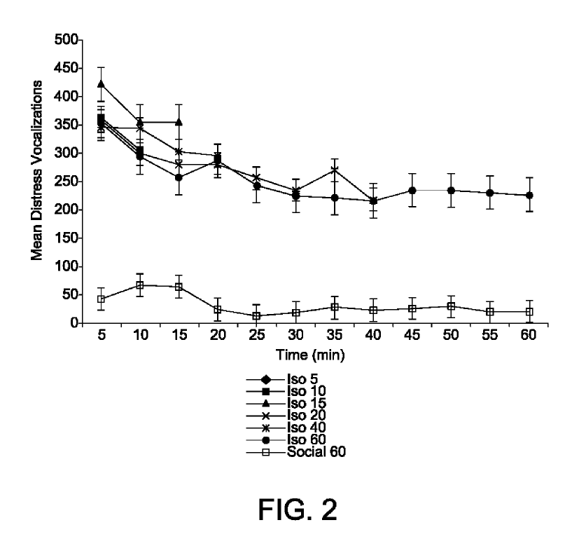

The effects of varying lengths of social separation on DVocs are summarized in FIG. 2. In animals tested in the social condition, DVocs were infrequent and remained stable across the 60 minute test session. For all of the other test groups, isolation from conspecifics produced a robust elevation in DVocs. This increase in DVocs gradually declined over the initial 20 minute period by approximately 30-40%, marking the emergence of learned helplessness. Thereafter, DVocs remained relatively stable throughout the remainder of the test session.

A time course analysis of the vocalization data in the social- and isolated-60 minute groups nicely illustrates both the stress effect of social separation and the emergence of learned helplessness in isolated chicks. Thus, a two-way repeated measures ANOVA conducted for these two groups revealed a significant main effect for Treatment [F(1,220)=78.51, p<0.0001], a significant main effect for Time [F(11,220)=5.15, p<0.0001], and a significant Treatment ×Time interaction [F(11, 220)=2.13, p<0.05].

A one-way repeated measures for the vehicle-social group revealed a significant effect for Time [F(11, 110)=1.91, p<0.05]. Post hoc analyses demonstrated that the only consistent and relevant difference in DVoc rates across time blocks was that chicks vocalized significantly more at the 10 and 15 minute blocks than each of the other test session blocks (p^{s}<0.05). To examine the ontogeny of learned helplessness, a one-way repeated measures for the vehicle-isolated group was performed and revealed a significant effect for Time [F(11, 110)=4.29, p<0.0001]. The results of post hoc analyses highlight three noteworthy patterns. First, DVocs were highest at the five minute time block and significantly lower for each of the remaining test session blocks (p^{s}<0.05). Second, there was no difference in DVoc between the 10, 15 and 20 minute time blocks as DVoc rates gradually declined. Finally, DVoc rates were stable across the 25-60 minute portion of the test session and these rates were significantly lower than the 5 and 10 minute blocks (p^{s}<0.05).

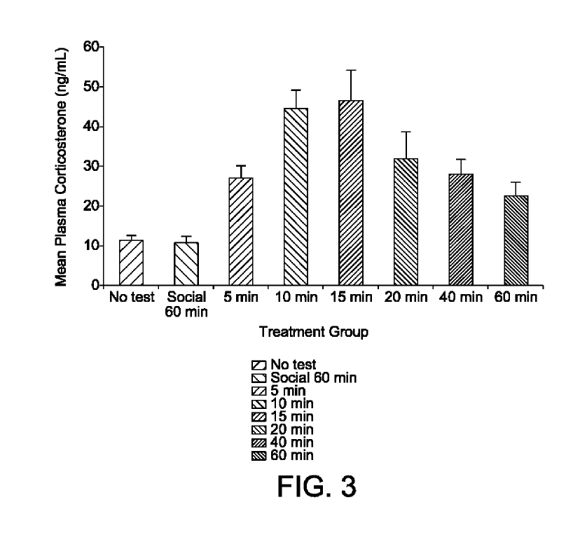

The effects of varying lengths of social separation stress on plasma corticosterone are summarized in FIG. 3. Levels of corticosterone in the social-60 group were comparable to the no-test control group, averaging approximately 11 ng/mL. Levels of corticosterone in the isolated groups were elevated and averaged between 22 and 46 ng/mL. The pattern of this stress-induced corticosterone response was marked by a peak in the isolated-10 and -15 minute groups, and a gradual decline in the 20, 40 and 60 minute isolation conditions.

To examine the effects of exposure to the testing protocol as well as the effects of social separation on plasma corticosterone levels, a one-way ANOVA was conducted on these data in the No-Test, Social-60 and Isolation-60 groups. This analysis revealed a significant effect for Treatment, F(2,14)=8.88, p<0.005. Post-hoc analyses of these data revealed that mean plasma corticosterone levels were significantly higher for the isolated-60 condition compared to the no-test and social-60 groups, p<0.005. To determine the effects of varying lengths of isolation on plasma corticosterone, a one-way ANOVA was conducted on data across the isolated groups. This analyses revealed a significant main effect for Time, F(5,29)=3.512, p<0.05. Post-Hoc analyses demonstrated that mean plasma corticosterone levels were significantly higher for the 10 and 15 minute groups compared to the 5, 40, and 60 minute groups, p^{s}<0.05.

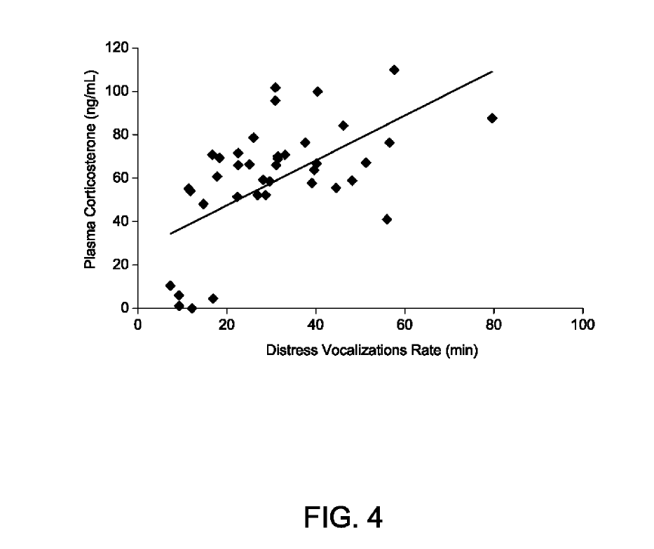

To examine the relationship between plasma corticosterone response and DVocs under increasing lengths of social separation, it was first necessary to convert DVocs to a rate/minute function (i.e., cumulative DVoc/isolation length). As is evident in FIG. 4, a positive relationship existed between plasma corticosterone levels and rate of distress vocalizations. A correlational analyses of these data yielded a significant effect (r=0.59, p<0.0001).

Distress vocalizations in the social-60 condition averaged below 50 Dvocs/5 minute block and remained stable throughout the test session (see FIG. 2). In chicks isolated for 60 minutes, distress vocalizations were approximately 350 vocalizations in the first five minute block, gradually declined over the 10-15 minute, and then stabilized between 200 and 250 DVocs/5 minute block throughout the remaining portion of the testing session. All other isolated groups demonstrated this behavioral trend, a pattern of which is indicative of learned helplessness. These results are consistent with that of Example 1 and demonstrate that the pattern of DVocs in isolated chicks is clearly characterized by three components: initial protest, behavioral despair and learned helplessness.

The no-test and social groups displayed essentially identical plasma corticosterone levels (11.29 and 11.13 respectively), indicating that the “low stress” (i.e. social) testing procedure does not elevate plasma corticosterone. However, isolation from social companions produced a marked elevation in plasma corticosterone. This finding is consistent with other studies demonstrating that plasma corticosterone is elevated in response to various external stressors, such as exposure to a predator, food deprivation, social separation, 24 hour illumination, and loud noises (C. Cook, Stress Induces CRF Release in the Paraventricular Nucleus, and Both CRF and BAGA Release in the Amygdala, 84(4) Physiol. and Behavior 751-62 (2004)); (P. Willner, Validity, Reliability, and Utility of the Chronic Mild Stress Model of Depression: A 10-Year Review and Evaluation, 134(4) Psychopharma. 319-29 (1997)). Plasma corticosterone was elevated for all of the isolated conditions. The increase in plasma corticosterone is most prominent for the isolated-10 and isolated-15 conditions. Plasma corticosterone levels declined for the isolated-20, -40, -60 conditions, but remained elevated in comparison to chicks tested in the social condition (See FIG. 3). Similar patterns of corticosterone responses (i.e., initial elevation and subsequent decline) have been found in rats subjected to maternal separation (P. M. Plotsky et al., Central and Feedback Regulation of Hypothalamic Corticotrophin-Releasing Factor Secretion. 172 Cibia Foundation Symposium. 59-84 (1993)) and is consistent with reports that corticosterone produces negative feedback on HPA axis activity (R. M. Sapolsky, Glucocorticoid Feedback Inhibition of Adrenocorticotropic Hormone Secretagogue Release, 51 Neuroendocrin. 328-36 (1990)).

As is evident in FIG. 4, a positive relationship exists between distress vocalizations and plasma corticosterone levels in chicks, one of which higher levels of plasma corticosterone correspond to higher distress vocalizations in isolated chicks. This finding is consistent with previous work in this lab that shows that a positive relationship (r=0.49) exists between corticosterone and distress vocalizations (M. W. Feltenstein et al., Corticosterone Response in the Chick Separation-Stress Paradigm. 78 Physiol. Behav. 489-93 (2003)). Whether corticosterone levels directly alter rates of distress vocalizations was not addressed in the experiment.

Previous research in young domestic fowl has demonstrated that isolation from social companions for up to two hours produces a pattern of DVocs that (E. Lehr, Distress Call Reactivation in Isolated Chicks: Behavioral Indicator With High Selectivity for Antidepressant Drugs, 97 Psychopharm. 145-46 (1989)) describes as a state akin to learned helplessness, a common symptom of depression that arises in response to an uncontrollable stressor and is associated with a loss of motivated behavior. According to Lehr, chicks exhibited an initial “protest” and subsequent “resignation” (i.e. learned helplessness) over the test session. However, Lehr provided no actual time-course data to characterize this pattern of behavior and uses cumulative DVocs for the two hr session as the measure of learned helplessness. We believe that Lehr's study conflates a model of anxiety with a model of depression.

Indeed, a time course analysis of DVocs and the differential efficacy of chlordiazepoxide and imipramine on the pattern of distress calls demonstrate that both anxiety and depression can effectively be modeled in chicks (see FIG. 1). In this invention, DVocs are maximal at the first five minute of the test session and marks the initial protest or the anxiety phase of the model. This is followed by a transitional phase we label behavioral despair and it is characterized by the notable decrease in DVocs during the next 10-15 minute of social separation. The final phase begins at about the 20 minute block and marks the beginning of the learned helplessness or depression phase of the model. This latter phase is characterized by reduced and stable pattern of DVocs for the remainder of the test session. We believe it is unnecessary to subject animals to the entire 1-2 hr test session to effectively model depression. In fact, we were capable of detecting imipramine's antidepressant effects in as little as five minute of DVoc sampling and as early as the 20 minute time block. While longer test sessions (e.g., up to 40 or 60 minute) do effectively capture the depression component and likely reduce variability it would be at the expense of model utility.

Isolation from social companions is a potent stressor in young domestic fowl and leads to increased activity of the HPA axis and elevated corticosterone levels. Corticosterone levels showed a peak response at 10-15 minute into the test session and gradually declined thereafter. It is interesting to note that corticosterone negative feedback in regulating activity of the HPA axis is largely dependent on the nature of the stressor. Research suggests that emotional stressors produce a greater negative feedback on the HPA axis activity than do physical stressors (Plotsky, et al., 1993 supra at 59-84). In the present experiment, the pattern of corticosterone response (i.e., the decline beyond 15 minute) indicates that social separation is an emotional stressor in the young domestic fowl and, thus, provides additional convergent validity of the paradigm as an anxiety/depression model.

Collectively, the behavioral, pharmacological and neuroendocrine data shown in Example 1 & 2 show that the present invention is a paradigm capable of screening compounds for anxiolytic and/or antidepressant activity. The advantages of the present invention over rodent-based depression models such as the Porsolt-forced swim test and the tail suspension test are numerous. Using the criteria outlined by (P. Willner, Behavioral Models In Psychopharmacology: Theoretical, Industrial and Clinical Perspectives, Cambridge University Press, Cambridge, pp. 3-18 (1991)) this assay possesses high utility and high-throughput as it 1) uses a low-cost animal ($0.50 a chick; (J. T. Roach et al. Characterization Of The Chick Carrageenan Response, 994 Brain Research 216-25 (2003)), 2) tests at a young age, 3) employs one relatively short test session (20-30 minute), 4) measures a species-typical response that is easily recorded, 5) screens for two drug properties in a single test and 6) requires simple statistical analyses. Furthermore, the present invention is unique in that it meets the NIH's 3R policy to Reduce, Refine, and Replace animals in research (Office of Laboratory Animal Welfare, 2002). The model reduces the number of purpose-bred research animals as male chicks are a by-product of the commercial egg-laying industry (i.e., cockerels are discarded at hatch; J. T. Roach & K. J. Sufka, Id. Also, the model possesses a refined methodology as it minimizes the stress-provoking stimuli to a single; relatively short (20-30 minute) test session. And finally, the model replaces the standard rodent-based models of anxiety with a phylogentically lower and less sentient species.

### EXAMPLE 3-5

### Day Drug Probe Studies

Subjects and Housing Procedures. Cockerels (Gallus gallus; W36; Cal-Maine Foods, Inc.; Mendenhall, Miss.) were received one-day post hatch and housed in 34×57×40 cm stainless steel cages with 12-13 chicks per cage. Food (Purina Start and Grow, St. Louis, Mo.) and water were available ad libitum through one quart gravity-fed feeders (Murray MacMurray; Model 4BGFJ) and waterers (Murray MacMurray; Model 4YQW0). Room temperature was maintained at 29±1° C. and overhead illumination was maintained on a 12 hr light-dark cycle. Daily maintenance, which was conducted during the first three hr of the light cycle, involved refilling the waterer, refilling the feeder, and replacement of tray liners.

Apparatus. The testing apparatus consisted of a six-unit test apparatus containing Plexiglas viewing chambers (25×25×22 cm) placed in sound-attenuating enclosures. Each unit was illuminated and heated by a 25-W light bulb. Ventilation was provided by an eight centimeter diameter rotary fan (Commonwealth Model FP-108AX S1). Miniature video cameras (SuperCircuit Model PC60XP) mounted in the sound-attenuating enclosures at floor level and routed through a Multiplexor (SuperCircuit Model PC47MC) provided televised display of the chicks for behavioral observation. Distress vocalizations (DVocs) were recorded by microphones (Lafayette Instruments Model 3-675-001) mounted in the ceilings of the Plexiglas chambers and connected to digital sound-activating relays (Lafayette Instruments Model 63040A; settings: 75% sensitivity and 0.10 s delay) that triggered electromechanical counters (Lafayette Instruments Model 58004).

Drugs. For the drug probes, either vehicle (0.9% physiological saline or DMSO) or the following drugs with established clinical efficacy for anxiety and/or depression were used in the experiments: chlordiazepoxide, 2.5, 5.0, 10.0, 15.0 mg/kg; clonidine, 0.10, 0.15, 0.20, 0.25 mg/kg; imipramine, 1, 3, 10, 15 mg/kg; maprotiline, 2.5, 5.0, 10.0, 20.0 mg/kg; fluoxetine, 1, 5, 10, 15 mg/kg.

Drug Probes. All experiments were conducted between five- and seven-days posthatch. The groups in each experiment formed a 1×5 factorial design with a hanging control condition (n=9-12). The two vehicle control groups constituted the social separation stress manipulation. This manipulation involved placing a chick in the Plexiglas test chamber either in isolation or with two social companions for a 120 min test observation period. All drug probes were tested in the isolation condition.

Vehicle or a drug was administered IM fifteen minutes prior to testing. Dependent measures that were collected during the test session were DVocs to index separation stress and sleep onset latency (SOL) to index sedation. DVocs were defined as the vocalizations that are picked up by the electromechanical counters. SOL was defined as the time in which a chick adopts a sleep-like posture with either its chest in full contact with the floor and its eyes closed or its legs in a wide posture, its head drooping, and its eyes closed. Following each six-chick test session, the animals were returned to their home cage. After all animals were tested, they were euthanized via CO² asphyxiation.

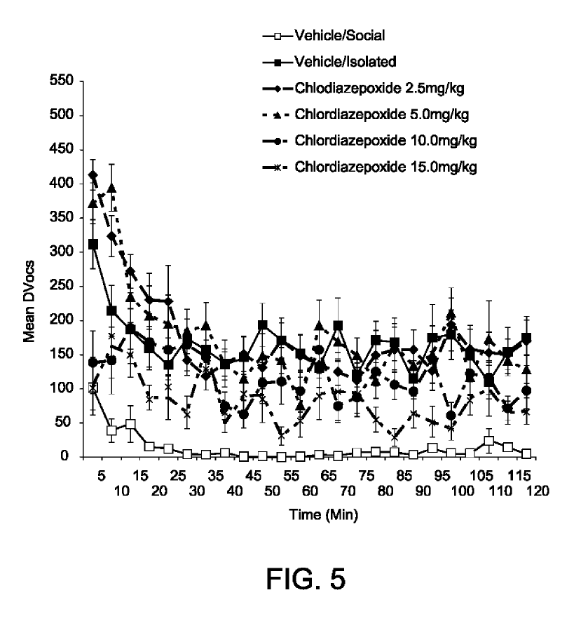

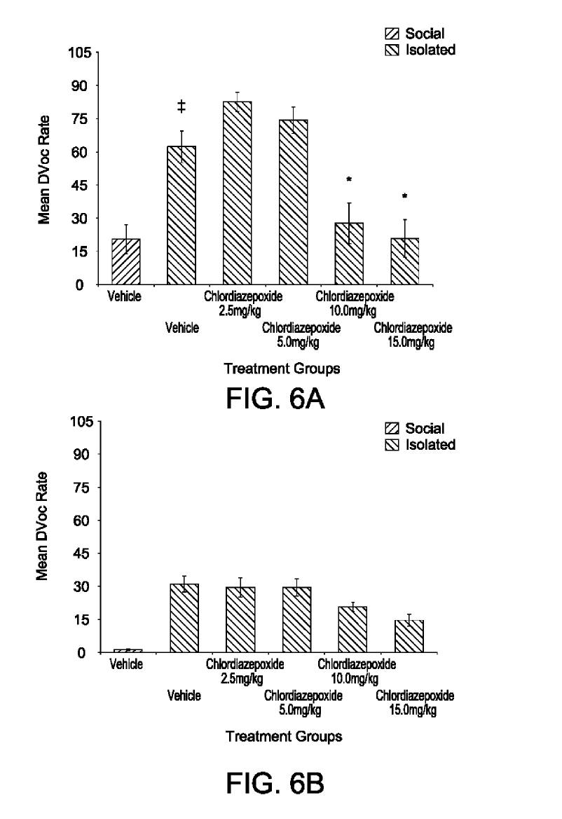

Chlordiazepoxide. The effects of social separation and chlordiazepoxide on DVocs across the test session are summarized in FIG. 5, while the effects of these factors on DVoc rates in the anxiety-like phase and the depression-like phase are summarized in FIGS. 6A and 6B. The two highest doses of chlordiazepoxide (10 mg/kg and 15 mg/kg) attenuated DVocs during the test session, most notably in the first five min time block (i.e., the anxiety-like phase), while none of the doses exacerbated DVocs during the test session. Consistent with these descriptions, at the five min time block a one-way ANOVA of the isolated groups revealed a significant effect [F(4, 56)=15.173, p<0.0001]. Post-hoc analyses showed a significant attenuation of the separation-induced DVoc rate at the 10 mg/kg and 15 mg/kg doses (p^{s}<0.005). A one-way ANOVA of the isolated groups during the depression-like phase (30-120 min) revealed a significant effect [F(4, 56)=4.341, p<0.005]. Post-hoc analyses demonstrated a significant attenuation of the DVoc rate in the 10 mg/kg and 15 mg/kg doses (p^{s}<0.025).

Chicks receiving the 10 mg/kg dose had a lower SOL compared to vehicle/isolated chicks. Consistent with this description, a one-way ANOVA revealed a marginally significant effect [F(4, 56)=2.268, p=0.074]. Post-hoc analyses demonstrated a significant SOL reduction in the 10 mg/kg dose (p<0.05).

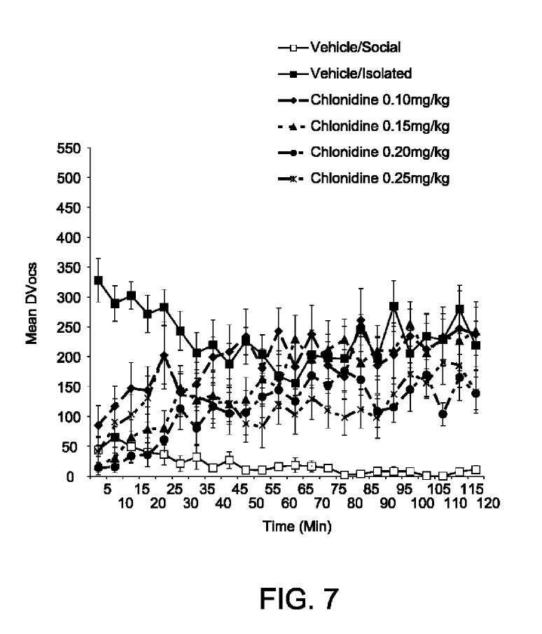

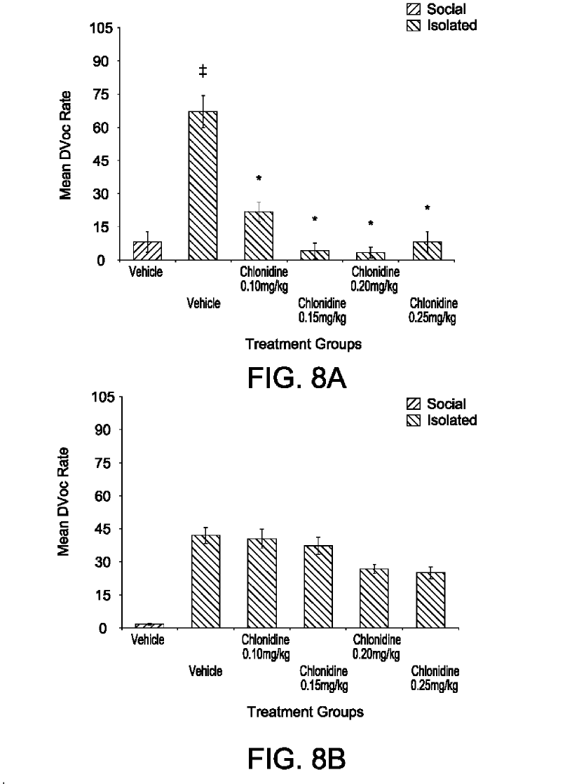

Clonidine. The effects of social separation and clonidine on DVocs across the test session are summarized in FIG. 7, while the effects of these factors on DVoc rates in the anxiety-like phase and the depression-like phase are summarized in FIGS. 8A and 8B. All doses of clonidine attenuated DVocs during the first five min time block (i.e., the anxiety-like phase), while none of the doses exacerbated DVocs during the test session. Consistent with these descriptions, a one-way ANOVA of the isolated groups revealed a significant effect at the five min time block [F(4, 56)=26.030, p<0.0001]. Post-hoc analyses showed a significant attenuation of the separation-induced DVoc rate at all doses (p^{s}<0.0001). A one-way ANOVA of the isolated groups during the depression-like phase (30-120 min) did not reveal a significant effect.

Chicks receiving the 0.15 mg/kg, 0.20 mg/kg and 0.25 mg/kg doses had a lower SOL compared to vehicle/isolated chicks. Consistent with this description, a one-way ANOVA revealed a significant effect [F(4, 56)=2.789, p<0.05]. Post-hoc analyses demonstrated a significant SOL reduction in the 0.15 mg/kg and 0.20 mg/kg doses (p^{s}<0.05) and a marginally significant reduction in the 0.25 mg/kg dose (p=0.085).

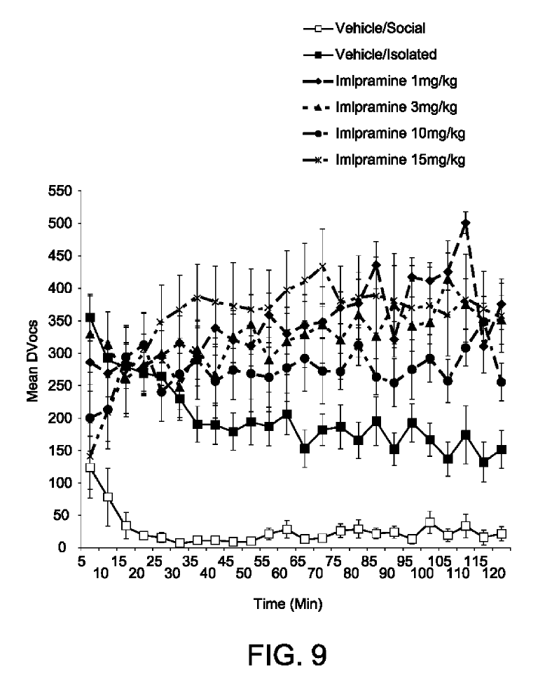

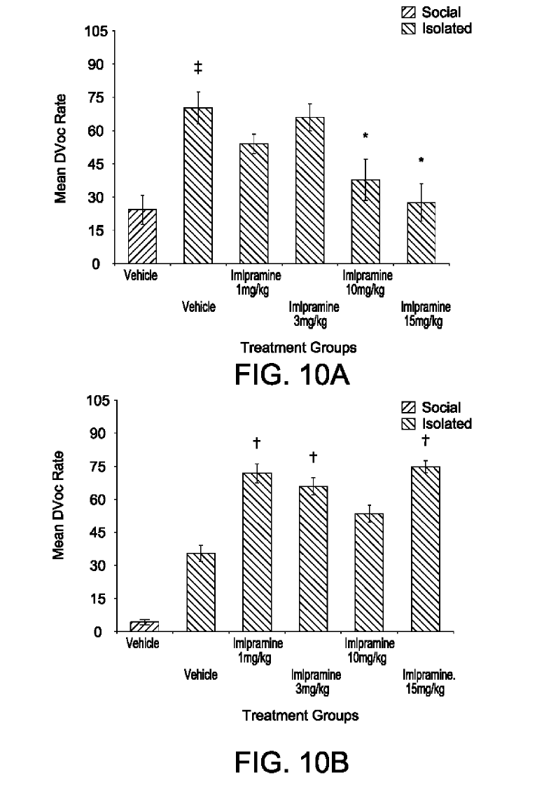

Imipramine. The effects of social separation and imipramine on DVocs across the test session are summarized in FIG. 9, while the effects of these factors on DVoc rates in the anxiety-like phase and the depression-like phase are summarized in FIGS. 10A and 10B. The two highest doses of imipramine (10 mg/kg and 15 mg/kg) attenuated DVocs during the anxiety-like phase of the test session (i.e., the first five min time block) and all of the doses exacerbated DVocs during the depression-like phase of the test session (i.e., the 30-120 min time block). Consistent with these descriptions, a one-way ANOVA of the isolated groups revealed a significant effect at the five min time block [F(4, 52)=3.456, p<0.025]. Post-hoc analyses showed a significant attenuation of the separation-induced DVoc rate at the 10 mg/kg and 15 mg/kg doses (p=^{s}<0.05). A one-way ANOVA of the isolated groups during the depression-like like phase (30-120 min) revealed a significant effect [F(4, 52)=5.044, p<0.005]. Post-hoc analyses demonstrated a significant exacerbation of the DVoc rate in the 1 mg/kg, 3 mg/kg and 15 mg/kg doses (p^{s}<0.005) and a marginally significant exacerbation in the 10 mg/kg dose condition (p=0.058).

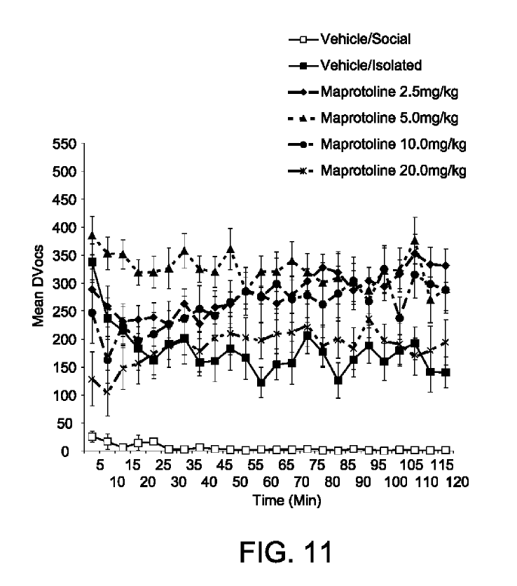

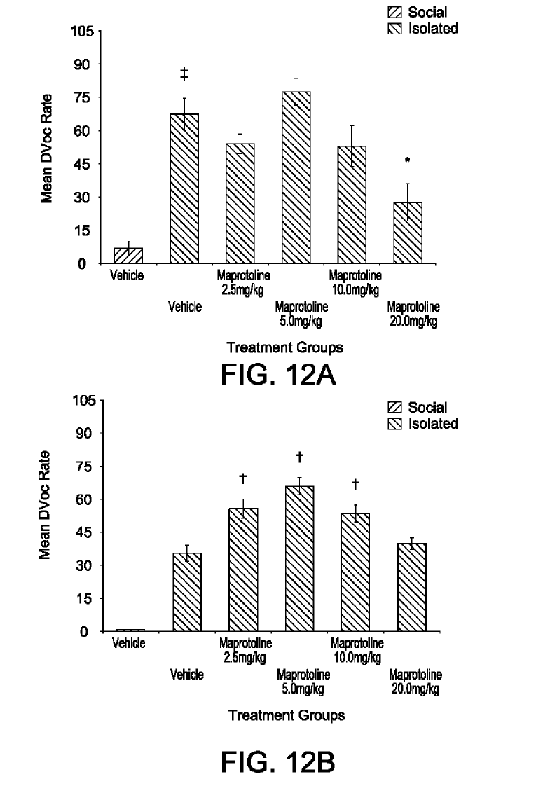

Maprotiline. The effects of social separation and maprotoline on DVocs across the test session are summarized in FIG. 11, while the effects of these factors on DVoc rates in the anxiety-like phase and the depression-like phase are summarized in FIGS. 12A and 12B. The highest dose of maprotiline (20 mg/kg) attenuated DVocs during the anxiety-like phase of the test session (i.e., the first five min time block), while the three lowest doses (2.5 mg/kg, 5 mg/kg, and 10 mg/kg) exaccerbated DVocs during the depression-like phase of the test session (i.e., 30-120 min time blocks). Consistent with these descriptions, a one-way ANOVA of the isolated groups revealed a significant effect at the five min time block [F(4, 59)=5.384, p<0.0001]. Post-hoc analyses showed a significant attenuation of the separation-induced DVoc rate at the 20 mg/kg dose (p<0.005). A one-way ANOVA of the isolated groups during the depression-like phase (30-120 min) revealed a significant effect [F(4, 59)=4.872, p<0.005]. Post-hoc analyses demonstrated a significant exaccerbation of the DVoc rate in the 1 mg/kg, 3 mg/kg and 15 mg/kg doses (p^{s}<0.01).

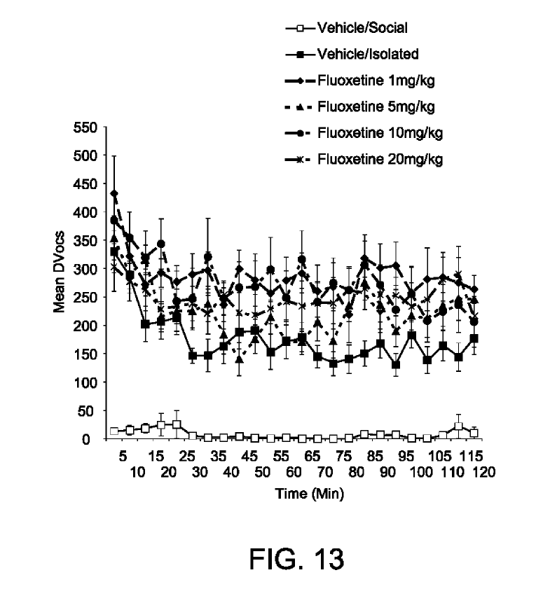

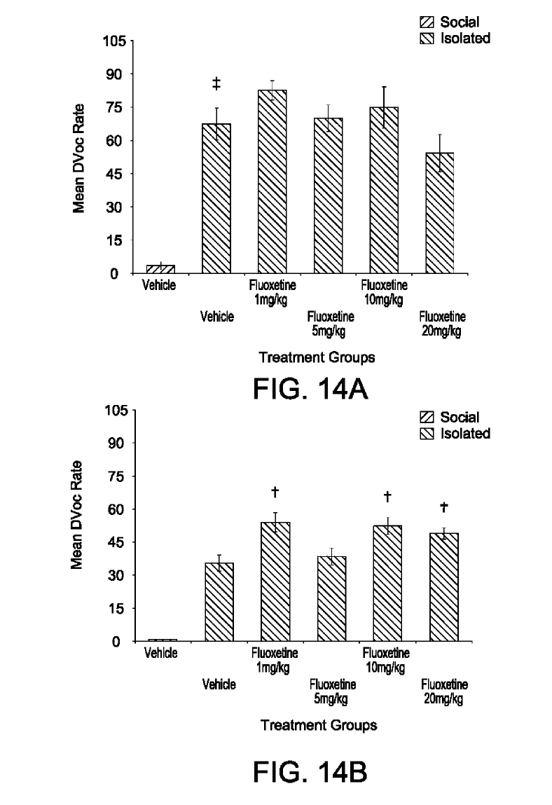

Fluoxetine. The effects of social separation and fluoxetine on DVocs across the test session are summarized in FIG. 13, while the effects of these factors on DVoc rates in the anxiety-like phase and the depression-like phase are summarized in FIGS. 14A and 14B. While none of the doses of fluoxetine attenuated DVocs during the anxiety-like phase of the test session (i.e., the first five min time block), the 1 mg/kg, 10 mg/kg, and 20 mg/kg doses exacerbated DVocs during the depression-like phase of the test session (i.e., 30-120 min time blocks). Consistent with these descriptions, a one-way ANOVA of the isolated groups did not reveal a significant effect at the five min time block. A one-way ANOVA of the isolated groups during the depression-like phase (30-120 min) revealed a significant effect [F(4, 54)=2.797, p<0.05]. Post-hoc analyses demonstrated a significant exacerbation of the DVoc rate in the 1 mg/kg, 10 mg/kg and 20 mg/kg doses (p^{s}<0.05).

### EXAMPLE 4

### IL-6 Assay

Subjects and Housing Procedures. Cockerels (Gallus gallus; W36; Cal-Maine Foods, Inc.; Mendenhall, Miss.) were received one-day post hatch and housed in 34×57×40 cm stainless steel cages with 12-13 chicks per cage. Food (Purina Start and Grow, St. Louis, Mo.) and water were available ad libitum through one quart gravity-fed feeders (Murray MacMurray; Model 4BGFJ) and waterers (Murray MacMurray; Model 4YQW0). Room temperature was maintained at 29±1° C. and overhead illumination was maintained on a 12 hr light-dark cycle. Daily maintenance, which was conducted during the first three hr of the light cycle, involved refilling the waterer, refilling the feeder, and replacement of tray liners.

Apparatus. The testing apparatus consisted of a six-unit test apparatus containing Plexiglas viewing chambers (25×25×22 cm) placed in sound-attenuating enclosures. Each unit was illuminated and heated by a 25-W light bulb. Ventilation was provided by an eight centimeter diameter rotary fan (Commonwealth Model FP-108AX S1). Miniature video cameras (SuperCircuit Model PC60XP) mounted in the sound-attenuating enclosures at floor level and routed through a Multiplexor (SuperCircuit Model PC47MC) provided televised display of the chicks for behavioral observation. Distress vocalizations (DVocs) were recorded by microphones (Lafayette Instruments Model 3-675-001) mounted in the ceilings of the Plexiglas chambers and connected to digital sound-activating relays (Lafayette Instruments Model 63040A; settings: 75% sensitivity and 0.10 s delay) that triggered electromechanical counters (Lafayette Instruments Model 58004).

The groups were tested for either 0, 15, 30, 60, or 120 minutes in isolation, or 120 min with social companions (n=6). Vehicle was administered IM fifteen minutes prior to testing. Following each test session, the animals were decapitated to allow for blood tissue collection. Blood samples were collected in EDTA tubes (BD Vauctainer K₃ EDTA) and immediately chilled on ice. Following the completion of the day's test session, blood was centrifuged for 15 min at 3000 rpm and plasma was removed. Plasma was stored at −80° C. until analysis. Plasma IL-6 concentrations were determined by an enzyme-linked immunosorbent assay (ELISA) kit (IL-6 Mouse EIA; ALPCO Diagnostics, Salem, N.H., USA). The assay was conducted according to the manufacturer's instructions. The intra-assay coefficient was 6.05%. For the IL-6 assay, only vehicle (0.9% physiological saline) was administered.

Statistical Analyses. In order to discretely analyze the drug effects in the anxiety-like state and the depression-like state, the raw DVoc data were converted to a rate per min score. The anxiety-like state DVoc rate consisted of the mean DVocs per min over the first five min of the test session. The depression-like state DVoc rate consisted of the mean DVocs per min from 30 min to 120 min. Following this conversion, the DVoc rates from the anxiety-like phase and depression-like phase were analyzed with a one-way ANOVA with Fisher's LSD post-hoc analysis. Plasma IL-6 concentration data were analyzed using one-way ANOVA with Fisher's LSD post-hoc analysis and independent sample t-tests.

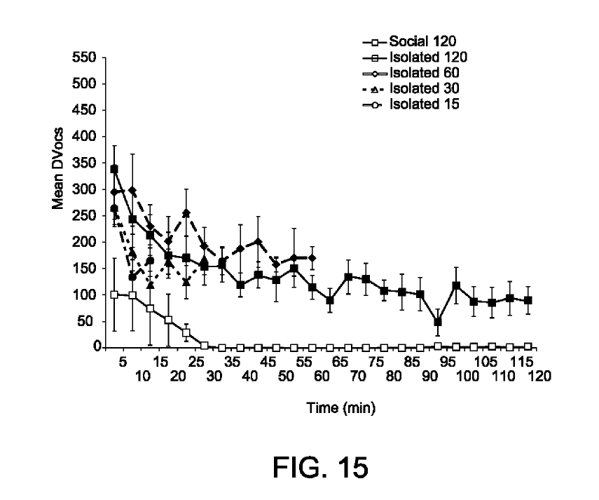

The effects of social separation on DVocs for chicks tested for IL-6 are summarized in FIG. 15. In the two hour test session groups, the Isolated 120 group had a robust increase in DVocs compared to the Social 120 group. Consistent with this description, a between subjects ANOVA revealed significant main effect for Social Condition [F(1, 10)=30.63, p<0.0001] and a within subjects ANOVA revealed a significant main effect for Time [F(23, 230)=5.99, p<0.0001] and a non-significant Social Condition ×Time interaction. In the Isolated 120 condtion, the DVoc rates changed within the test session with the highest point occurring in the first five min time block (i.e., anxiety-like phase) followed by a decrease to 60% of that initial rate by the 15 min time block. DVoc rates stayed between 60% to 14% of the first five min block for the rest of the test session (i.e., depression-like phase). A repeated measures ANOVA conducted on the Isolated 120 group revealed a significant main effect [F(23, 115)=4.95, p<0.0001]. Paired samples t-tests showed significantly fewer DVocs for every time block (ten min-120 min) compared to the first five min time block (all p^{s}<0.05). All other Isolated conditions displayed a similar pattern with the DVoc rates changing within the test session, with the highest point occurring in the first five min time block (i.e., anxiety-like phase) followed by a decrease of that initial rate by the 15 min time block (all p^{s}<0.05).

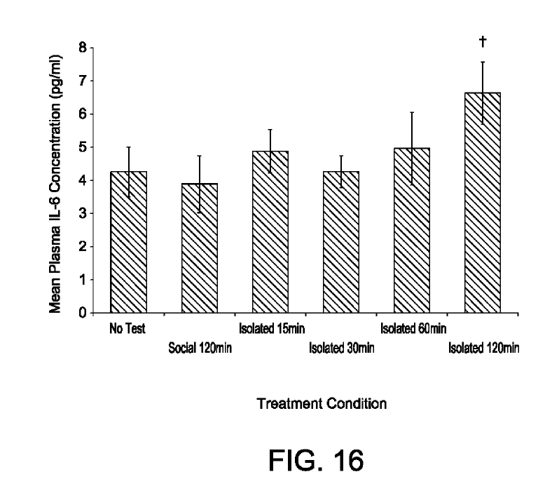

The effects of varying lengths of social separation on mean plasma IL-6 concentrations are summarized in FIG. 16. IL-6 levels were comparable between the No Test and the Social 120 min groups. The Isolated 120 group had IL-6 levels higher than either the No Test or Social 120 groups. All other Isolated groups had IL-6 levels between that of the Isolated 120, No Test and Social 120 groups. Consistent with this description, a one-way ANOVA of the No Test, Social 120 and Isolated 120 groups revealed marginally significant main effect [F(2, 17)=3.06, p=0.077]. Post-hoc analyses show no significant difference between the No Test and Social 120 groups, a marginally significant difference between the No Test and Isolated 120 groups (p=0.067), and a significant difference between the Social 120 and Isolated 120 groups (p<0.05). A one-way ANOVA of the Isolated groups was not significant. Post-hoc analyses reveal a marginally significant difference between the Isolated 120 and Isolated 30 groups (p=0.055).

While the foregoing description has set forth the various embodiments of the present invention in particular detail, it must be understood that numerous modifications, substitutions and changes can be undertaken without departing from the true spirit and scope of the present invention as defined by the ensuing claims. The invention is therefore not limited to specific preferred embodiments as described, but is only limited as defined by the following claims.

What is claimed is:

1. A method to screen for at least one drug wherein said at least one drug has anxiolytic or antidepressant activity in a plurality of fowl chicks comprising the step of:
a) providing said plurality of fowl chicks, wherein a first portion of said plurality of fowl chicks receives said at least one drug and a second portion of said plurality of fowl chicks do not receive said at least one drug;
b) audibly separating at least one fowl chick from said first portion and second portion of fowl chicks;
c) detecting DVocs rate from said at least one separated fowl chick at a first and second time; and
d) comparing the DVocs rate of said at least one separated fowl chick from said first portion of fowl chicks and from said second portion of fowl chicks at a first and second time to screen for at least one drug.

2. The method of claim 1 wherein said at least one fowl chick is separated for between 1 to 15 minutes.

3. The method of claim 2 wherein said at least one fowl chick is separated for 5 minutes.

4. The method of claim 2 wherein said DVocs rate is indicative of anxiety in said at least one separated fowl chick.

5. The method of claim 4 wherein said at least one drug has anxiolytic activity as shown by a decrease in said DVocs rate.

6. The method of claim 1 wherein said at least one fowl chick from said first portion and second portion of fowl chicks is separated for between 20-120 minutes.

7. The method of claim 6 wherein said at least one fowl chick from said first portion and second portion of fowl chicks is separated for between 20-40 minutes.

8. The method of claim 6 wherein said DVocs rate is indicative of depression in said separated chick fowl.

9. The method of claim 8 wherein said at least one drug has antidepressant activity as shown by an increase in said DVocs rate.

10. The method of claim 1 further comprising adjusting the said at least one drug to determine optimum dosage.

11. A system to screen for at least one drug having anxiolytic or antidepressant activity comprising:
a) a plurality of fowl chicks, wherein a first portion of said plurality of fowl chicks receives said at least one drug and a second portion of said plurality of fowl chicks do not receive said at least one drug;
b) means to audibly separate a fowl chick from said first portion of fowl chicks and from said second portion of fowl chicks;
c) means to determine DVocs rate of said fowl chick from said first portion of fowl chicks and from said second portion of fowl chicks at a first and second time; and
d) means to compare DVocs rate of said fowl chick from said first portion of fowl chicks and from said second portion of fowl chicks to screen for said at least one drug having anxiolytic or antidepressant activity.
